(19) United States
(12) Patent Application Publication
(10) Pub. No.: US 2025/0378829 A1
(43) Pub. Date: Dec. 11, 2025

(54) CONTEXT-BASED SPEECH PROCESSING

(71) Applicants: Beijing Zitiao Network Technology Co., Ltd., Beijing (CN); Lemon Inc., Grand Cayman (KY)

(72) Inventors: Yizhou Lu, Beijing (CN); Linhao Dong, Beijing (CN); Lu Lu, Los Angeles, CA (US)

(21) Appl. No.: 19/233,683

(22) Filed: Jun. 10, 2025

(51) Int. Cl. G10L 15/197; G10L 15/06

(52) U.S. Cl. CPC G10L 15/197; G10L 15/063

(57) ABSTRACT

Embodiments in the disclosure relate to context-based speech processing. In an example method provided by the disclosure, training data is obtained, including a speech sample, context information associated with the speech sample, and annotation text corresponding to the speech sample. A first output probability corresponding to the annotation text is determined by processing a first feature sequence using a speech recognition model. The first feature sequence is constructed based on the speech sample and the context information. A second output probability corresponding to the annotation text is determined by processing a second feature sequence using the speech recognition model. The second feature sequence is constructed based on the speech sample and is independent of the context information. A training loss based on at least a difference between the first output probability and the second output probability is determined to adjust a parameter of the speech recognition model.

### CROSS-REFERENCE

This application claims priority to Chinese Patent Application No. 202410749788.X, filed on Jun. 11, 2024 and entitled “METHOD, APPARATUS, DEVICE AND STORAGE MEDIUM FOR CONTEXT-BASED SPEECH PROCESSING”, the entire content of which is incorporated herein by reference.

### FIELD

Example embodiments of the present disclosure generally relate to the field of computers, and in particular, to context-based speech processing.

### BACKGROUND

In recent years, with the rapid development of computer technologies, more and more applications and platforms are designed to provide various services to users. For example, applications/platforms are designed to provide speech recognition services to the users. The application/platform may, for example, implement speech to text by means of a speech recognition system (for example, a speech recognition model), and generating text corresponding to the speech.

### SUMMARY

In a first aspect of the present disclosure, a method of context-based speech processing is provided. The method includes: obtaining training data, the training data including a speech sample, context information associated with the speech sample, and annotation text corresponding to the speech sample; determining a first output probability corresponding to the annotation text by processing a first feature sequence using a speech recognition model, the first feature sequence constructed based on the speech sample and the context information; determining a second output probability corresponding to the annotation text by processing a second feature sequence using the speech recognition model, where the second feature sequence is constructed based on the speech sample and is independent of the context information; and determining a training loss based on at least a difference between the first output probability and the second output probability to adjust a parameter of the speech recognition model.

In a second aspect of the present disclosure, an apparatus for context-based speech processing is provided. The apparatus includes an obtaining module, configured to obtain training data, the training data including a speech sample, context information associated with the speech sample, and annotation text corresponding to the speech sample; a first determination module, configured to determine a first output probability corresponding to the annotation text by processing a first feature sequence using a speech recognition model, the first feature sequence constructed based on the speech sample and the context information; a second determination module, configured to determine a second output probability corresponding to the annotation text by processing a second feature sequence using the speech recognition model, where the second feature sequence is constructed based on the speech sample and is independent of the context information; and an adjusting module, configured to determine a training loss based on at least a difference between the first output probability and the second output probability to adjust a parameter of the speech recognition model.

In a third aspect of the present disclosure, an electronic device is provided. The apparatus includes at least one processing unit; and at least one memory coupled to the at least one processing unit and storing instructions for execution by the at least one processing unit. The instructions, when executed by the at least one processing unit, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the summary described in this disclosure is not intended to limit key features or important features of implementations in the present disclosure, nor is it intended to limit the scope in the present disclosure. Other features in the present disclosure will become readily understood from the following description.

### BRIEF DESCRIPTION OF DRAWINGS

The above and other features, advantages, and aspects of the various implementations in the present disclosure will become more apparent from the following detailed description taken in combination with the accompanying drawings. In the drawings, the same or similar reference numbers refer to the same or similar elements, where:

FIG. 1 illustrates a schematic diagram of an example environment in which embodiments according to the present disclosure may be implemented;

FIG. 2 illustrates a flowchart of an example process of context-based speech processing according to some embodiments of the present disclosure;

FIG. 3 illustrates a schematic diagram of an example framework of a speech recognition model according to some embodiments of the present disclosure;

FIG. 4 shows a schematic structural block diagram of an example apparatus for context-based speech processing according to some embodiments of the present disclosure; and

FIG. 5 illustrates a block diagram of an electronic device capable of implementing various embodiments of the present disclosure.

### DETAILED DESCRIPTION

The embodiments in the present disclosure will be described in more detail below with reference to the accompanying drawings. Although certain embodiments in the present disclosure are shown in the drawings, it would be appreciated that the present disclosure can be implemented in various forms and should not be interpreted as limited to the embodiments described in this specification. On the contrary, these embodiments are provided for a more thorough and complete understanding in the present disclosure. It would be appreciated that the accompanying drawings and embodiments in the present disclosure are only for the purpose of illustration and are not intended to limit the scope of protection in the present disclosure.

It should be noted that the headline of any section/subsection provided in the specification is not limiting. Various embodiments are described throughout the specification and any type of embodiments may be included in any section/subsection. Furthermore, the embodiments described in any section/subsection may be combined in any manner with any other embodiment described in the same section/subsection and/or different sections/subsections.

In the description of the embodiments of the present disclosure, the term “including” and similar terms would be appreciated as open-ended inclusion, that is, “including but not limited to”. The term “based on” would be appreciated as “at least partially based on”. The term “one embodiment” or “the embodiment” would be appreciated as “at least one embodiment”. The term “some embodiments” would be appreciated as “at least some embodiments”. Other explicit and implicit definitions may also be included below. The terms “first,” “second,” and the like may refer to different or same objects. Other explicit and implicit definitions may also be included below.

The embodiments in the present disclosure may relate to user data, acquisition and/or use of data, and the like. These aspects shall comply with the requirements of corresponding laws, regulations and relevant provisions. In the embodiments in the present disclosure, the collection, acquisition, processing, manufacturing, forwarding, use of all data and the like are carried out with user's knowledge and consent. Accordingly, in the implementation of the embodiments in the present disclosure, users should be informed of the type, the scope of use, the use scenario, etc., of the involved data or information in an appropriate manner and provide authorization in accordance with relevant laws and regulations. The specific ways of being informed and providing authorization may vary according to actual circumstances and application scenarios, and the scope of this disclosure is not limited in this regard.

In the solutions and embodiments in this disclosure, if personal information processing is involved, it will be carried out based on legitimate grounds (such as obtaining consent from the data subject, or as required to fulfill a contract, etc.) and will be performed only within a specified or agreed scope. If users decline the processing of personal information beyond what is essential for basic functionalities, their utilization of these basic features remains uninterrupted.

As used herein, the term “model” may learn, from training data, associations between respective inputs and outputs, so that a corresponding output may be generated for a given input after training is completed. The generation of the model may be based on a machine learning technology. Depth learning is a machine learning algorithm that processes inputs and provides corresponding outputs by using multiple layers of processing units. A neural networks model is one example of a deep learning-based model. As used herein, “model” may also be referred to as “machine learning model,” “learning model,” “machine learning network,” or “learning network,” and these terms may be used interchangeably herein.

Generally, machine learning may roughly include three stages: a training stage, testing stage, and usage stage (also referred to as an inference stage). In the training stage, a given model may be trained using a large amount of training data, constantly iterating to update a parameter value, until the model is able to obtain, from the training data, consistent inferences that meet expected goals. Through training, the model may be considered to be able to learn, from training data, associations (also referred to as mappings from inputs to outputs) between inputs to outputs. In the testing stage, a test input is applied to the trained model to test whether the model can provide a correct output, thereby determining the performance of the model. The testing stage sometimes may be integrated into the training stage. In the application or inference stage, the model can process, based on the parameter values obtained from training, actual inputs to determine corresponding outputs.

As mentioned above, with the rapid development of computer technology, more and more applications and platforms are designed to provide various services to users. For example, an application/platform may be designed to provide speech recognition services to users. The application/platform may, for example, implement speech to text by means of a speech recognition system (for example, a speech recognition model) to generate text corresponding to the speech. However, the text content generated by the conventional speech recognition system is not sufficiently accurate.

The embodiments in the present disclosure provide a context-based speech processing solution. According to the scheme, training data is obtained. The training data includes a speech sample, context information associated with the speech sample, and annotation text corresponding to the speech sample. A first output probability corresponding to the annotation text is determined by processing a first feature sequence using a speech recognition model. The first feature sequence is constructed based on the speech sample and the context information. A second output probability corresponding to the annotation text is determined, by processing a second feature sequence using the speech recognition model. The second feature sequence is constructed based on the speech sample and is independent of the context information. A training loss is determined based on at least a difference between the first output probability and the second output probability to adjust a parameter of the speech recognition model.

In this way, embodiments of the present disclosure may improve accuracy of speech recognition based on context information.

Various example implementations of this scheme are described in detail below in conjunction with the accompanying drawings.

### Example Environment

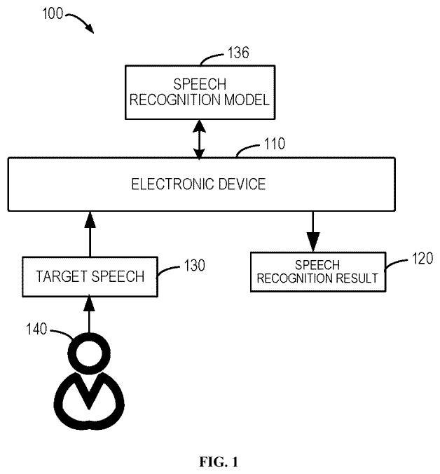

FIG. 1 illustrates a schematic diagram of an example environment 100 in which embodiments of the present disclosure can be implemented. In the environment 100, an electronic device 110 and a speech recognition model 136 are deployed. In some embodiments, the electronic device 110 receives a target speech 130 from a user 140. Then the electronic device 110 invokes the speech recognition model 136 to generate a speech recognition result 120 based on the target speech 130.

In some embodiments, the speech recognition model 136 includes at least a language model, a speech encoding model, a transformer, and the like. The electronic device 110 may generate a speech feature representation using the speech encoding model in the speech recognition model 136. The electronic device 110 generates the speech recognition result 120 based on the speech feature representation and context information by using the language model in the speech recognition model 136. In some embodiments, the speech recognition model may run on a local device or a remote device.

In some embodiments, the electronic device 110 may include various types of computing systems/servers capable of providing computing capability, and the electronic device 110 may include a terminal device. Such terminal devices may be any type of mobile terminal, fixed terminal, or portable terminal, including mobile handsets, desktop computers, laptop computers, notebook computers, netbook computers, tablet computers, media computers, multimedia tablets, personal communication systems (PCS) devices, personal navigation devices, personal digital assistants (PDAs), speech/video players, digital cameras/camcorders, positioning devices, television receivers, radio broadcast receivers, electronic book devices, gaming devices, or any combination thereof, including accessories and peripherals of these devices, or any combination thereof. The electronic device 110 may include, for example, various types of computing systems/servers capable of providing computing capability, such as mainframes, edge computing nodes, computing devices in a cloud environment, virtual machines, and the like. Although shown as a single device, the electronic device 110 may include multiple physical devices.

It should be understood that the structures and functions of the various elements in the environment 100 are described for illustrative purposes only and do not imply any limitation to the scope of the present disclosure.

Some example embodiments of the present disclosure will be described below with continued reference to the accompanying drawings.

### Speech Processing Based on Context Information

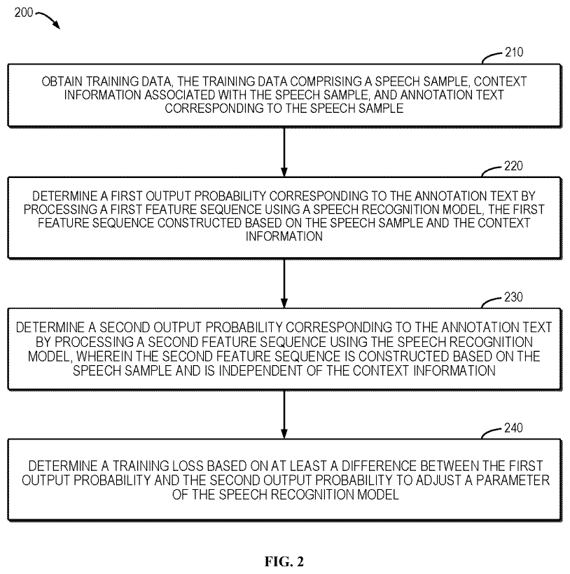

FIG. 2 illustrates a flowchart of an example process 200 of context-based speech processing in accordance with some embodiments in the present disclosure. The process 200 may be implemented at the electronic device 110. The process 200 is described below with reference to FIG. 1.

As shown in FIG. 2, in block 210, the electronic device 110 may obtain training data. The training data includes a speech sample, context information associated with the speech sample, and annotation text corresponding to the speech sample.

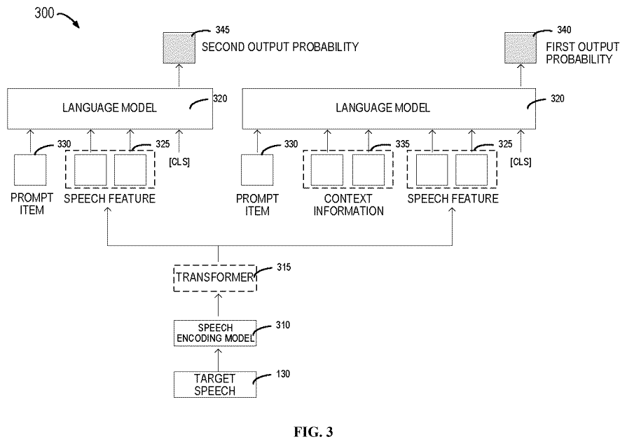

An example process of training a speech recognition model, according to the embodiments in the present disclosure will be described below with reference to the speech recognition model 136 shown in FIG. 3.

FIG. 3 illustrates a schematic diagram of an example framework 300 of a speech recognition model 136 according to some embodiments in the present disclosure. As shown in the example framework 300 of FIG. 3, the speech recognition model 136 may include a speech encoding model 310, a transformer 315 (alternatively), and a language model 320.

In some embodiments, referring to FIG. 3, in the training stage, the input information of the speech recognition model 136 may include training data. The training data may include target speech 130 (e.g., also referred to as speech samples in the training stage), context information 335 associated with speech samples, and annotation text corresponding to the speech sample. As an example, the annotation text may be text content corresponding to the speech sample.

In some embodiments, the annotation text corresponding to the speech sample may be provided to the text generation model. Alternatively, historical annotation text of historical speech content associated with the speech sample may also be provided to the text generation model. Further, the text generation model may generate description text about the annotation text. Further, the text generation model may construct the context information corresponding to the speech sample based on the description text. As an example, the description text about the annotation text may describe one or more of related content such as a dialog scenario of the annotation text, a dialog object, text content, a title of the speech sample, and the like. As an example, the historical annotation text may indicate a historical background of the annotation sample. As an example, the text generation model may be implemented as any suitable model such as a language model, and the present disclosure is not intended to limit the specific implementation of the text generation model.

In some embodiments, referring to FIG. 3, the speech encoding model 310 (for example, also referred to as an encoding unit) may generate a speech feature 325 (for example, also referred to as a speech feature sequence, a speech encoding representation) corresponding to the target speech 130 based on the target speech 130. As an example, the speech encoding model 310 may be implemented, for example, as an suitable encoding model such as a neural network.

In some embodiments, with continued reference to FIG. 3, the speech encoding model 310 may generate a first speech feature corresponding to the target speech 130 based on the target speech 130. Further, the transformer 315 (e.g., also referred to as a transformation unit) may transform the first speech feature generated by the speech encoding model 310 into the speech feature 325 suitable for processing by the language model 320. As an example, the transformer 315 may be implemented, for example, based on a modality transformer.

At block 220, the electronic device 110 determines a first output probability corresponding to the annotation text by processing a first feature sequence using the speech recognition model 136. The first feature sequence may be constructed based on the speech feature 325 and the context information 335 of the speech samples.

In some embodiments, with continued reference to FIG. 3, the speech recognition model 136 may process the first feature sequence to determine a first output probability 340 corresponding to the annotation text. In some embodiments, the speech recognition model 136 may include the language model 320, which may be configured to process the first feature sequence to generate the first output probability 340.

In some embodiments, a prompt item 330 (e.g., also referred to as a guidance feature sequence) may prompt the language model 320 to perform a speech recognition task.

In some embodiments, the first output probability 340 may indicate a first probability of a target token corresponding to the annotation text. It may be understood that the target token may include at least one word or character. The first output probability may indicate the first probability corresponding to at least one word or character in the target token. The first output probability may be represented by p(yₙ|x, c, y_{<n}), where x indicates a sequence corresponding to the speech feature 325, c indicates a sequence corresponding to the context information 335, and n indicates the n—the step in each decoding step. In some examples, in the process of training the speech recognition model 136, the electronic device 110 respectively inputs the sequence corresponding to the prompt item 330, the sequence corresponding to the context information 335, and the sequence corresponding to the speech feature 325 into the language model 320, to generate a final speech recognition output sequence y_{1,2, . . . N} based on the input as a condition.

At block 230, the electronic device 110 may determine a second output probability corresponding to the annotation text by processing a second feature sequence using the speech recognition model 136. The second feature sequence may be constructed based on the speech feature 325 of the speech sample, and the second feature sequence is independent of the context information.

In some embodiments, with continued reference to FIG. 3, the speech recognition model 136 may further process the second feature sequence to determine a second output probability 345 corresponding to the annotation text. In some embodiments, the language model 320 may process the second feature sequence to generate the second output probability 345. As shown in FIG. 3, the second feature sequence does not include a sequence portion corresponding to the context information 335, which is different from the first feature sequence.

In some embodiments, the second output probability 345 may indicate a second probability of the target token corresponding to the annotation text. The second output probability may indicate a second probability corresponding to at least one word or character in the target token. The second output probability may be represented by p(yₙ|x, y_{<n}), where x indicates a sequence corresponding to the speech features 325, and n indicates the n-th step in each decoding step. In some examples, in the process of training the speech recognition model 136, the electronic device 110 respectively inputs the sequence corresponding to the prompt item 330 and the sequence corresponding to the speech feature 325 into the language model 320, to generate a final speech recognition output sequence y_{1,2, . . . N} based on the input as a condition.

At block 240, the electronic device 110 determines a training loss based on at least a difference between the first output probability and the second output probability to adjust a parameter of the speech recognition model 136.

In some embodiments, with continued reference to FIG. 3, the training loss may be constructed based on the difference between the first output probability and the second output probability. The training loss may include a first portion corresponding to the first output probability, a second portion corresponding to the second output probability, and a third portion corresponding to the difference.

As an example, the first portion corresponding to the first output probability may be represented by λ*logp₂(yₙ|x, c, y_{<n}), and the second portion corresponding to the second output probability may be represented by (λ−1)*logp₁ (yₙ|x, y_{<n}), where λ may represent a weight coefficient associated with the first output probability and the second output probability, which is set as needed, and log may represent a natural logarithm with base e (Euler's number, approximately equal to 2.71828); p₁ may be an abbreviation for p₁(yₙ|x, y_{<n}); and p₂ may be an abbreviation for p₂(yₙ|x, c, y_{<n}).

In some embodiments, the difference may include a JS (Jensen-Shannon) divergence determined based on the first output probability and the second output probability. As an example, the third portion corresponding to the difference may be represented by α*JSD(p₁∥p₂). The JSD(p₁∥p₂) may be represented as

$$\frac{1}{2} [ {D}_{KL} ( {p}_{1} ‖ M ) + {D}_{KL} ( {p}_{2} ‖ M ) ] ,$$

where M may be represented as

$$\frac{1}{2} ( {p}_{1} + {p}_{2} ) , {D}_{KL} ( {p}_{1} ‖ M )$$

may be represented as

$${\sum }_{n} {p}_{1} ( \frac{{p}_{1}}{M} ) , and {D}_{KL} ( {p}_{2} ‖ M )$$

may be represented as

$${\sum }_{n} {p}_{2} ( \frac{{p}_{2}}{M} ) ,$$

α may be represent as the weight coefficient associated with the difference, which is set as needed.

In some embodiments, the training loss based on the first output probability, the second output probability, and the JS divergence may be expressed as:

$$( λ - 1 ) * log {p}_{1} ( {y}_{n} \vert x , {y}_{< n} ) - λ * log {p}_{2} ( {y}_{n} \vert x , c , {y}_{< n} ) + α * JSD ( {p}_{1} ‖ {p}_{2} ) \qquad ( 1 )$$

In some embodiments, the difference may include a KL (Kullback-Leibler) divergence determined based on the first output probability and the second output probability. As an example, the third portion corresponding to the difference may be represented by

$$\frac{α}{2} [ {D}_{KL} ( {p}_{1} ‖ {p}_{2} ) + {D}_{KL} ( {p}_{2} ‖ {p}_{1} ) ] ,$$

where D_{KL}(p₁∥p₂) may be represented as

$${\sum }_{n} {p}_{1} ( \frac{{p}_{1}}{{p}_{2}} ) ,$$

and D_{KL}(p₂∥p₁) may be represented as

$${\sum }_{n} {p}_{2} ( \frac{{p}_{2}}{{p}_{1}} ) ,$$

α may be represented as the weight coefficient associated with the difference, which is set as needed.

In some embodiments, the training loss determined based on the first output probability, the second output probability, and the KL divergence may be expressed as:

$$( λ - 1 ) * log {p}_{1} ( {y}_{n} \vert x , {y}_{< n} ) - λ * log {p}_{2} ( {y}_{n} \vert x , c , {y}_{< n} ) + \frac{α}{2} [ {D}_{KL} ( {p}_{1} ‖ {p}_{2} ) + {D}_{KL} ( {p}_{2} ‖ {p}_{1} ) ] \qquad ( 2 )$$

In some embodiments, with continued reference to FIG. 3, in the inference stage, the trained speech recognition model 136 may obtain the target speech 130 to be processed (for example, may be referred to as target speech content) and target context information associated with the target speech content.

In some embodiments, the target context information may indicate at least one of the following: text content, scene information, and object information. In some embodiments, the text content is generated by the historical speech content associated with the target speech content. That is, according to the historical speech content associated with the target speech content 130, the text content may be generated as the context information.

In some embodiments, the scenario information may describe a dialogue scenario associated with the target speech content. For example, a conversation scenario associated with the current target speech is configured as the context information. In some embodiments, the object information may describe at least one object associated with the target speech content. For example, in the interaction process related to the target speech content, the involved user name, the name of the digital assistant, and the like may be configured as the context information. For another example, the topic involved in the conference scenario associated with the target speech content, the involved document, and the like may be configured as the context information.

It should be understood that the text content, scenario information, object information, and other data (including but not limited to the data itself, the acquisition or use of data) mentioned in the present disclosure should follow the requirements of the applicable laws, regulations, and relevant provisions.

Further, the trained speech recognition model 136 may generate the speech feature (for example, also referred to as a speech feature sequence) corresponding to the target speech content using the speech encoding model 310 (for example, also referred to as a the encoding unit) and the transformer 320 (for example, also referred to as the transformation unit).

Further, the trained speech recognition model 136 may construct an input feature sequence based on the speech feature sequence, the context feature sequence, and the guidance feature sequence. Specifically, the context feature sequence may correspond to the target context information, and the guidance feature sequence may correspond to a predetermined guidance item (for example, indicating to perform speech recognition). Further, the trained speech recognition model 136 may process the input feature sequence using the language model 320 to generate the speech recognition result for the target speech content.

Based on the solution for context-based speech processing described above, the embodiments in the present disclosure may suppress the model hallucination problem by integrating the output result related to the context information and the output result independent of the context information, thereby improving the accuracy of the speech recognition model.

### Example Apparatus and Apparatus

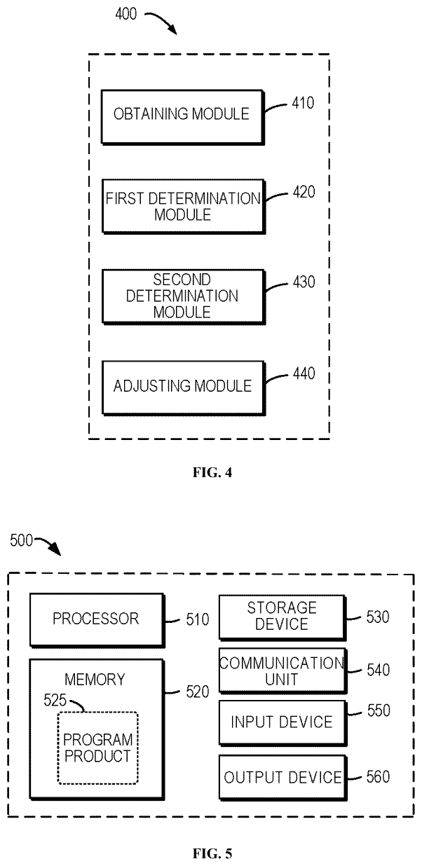

The embodiments in the present disclosure also provide a corresponding apparatus for implementing the above method or process. FIG. 4 illustrates a schematic structural block diagram of an example apparatus 400 for context-based speech processing according to some embodiments in the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes an obtaining module 410, configured to obtain training data. The training data includes a speech sample, context information associated with the speech sample, and annotation text corresponding to the speech sample. The apparatus 400 also includes a first determination module 420, configured to determine a first output probability corresponding to the annotation text by processing the first feature sequence by using the speech recognition model. The first feature sequence is constructed based on the speech sample and the context information. The apparatus 400 further includes a second determination module 430, configured to determine a second output probability corresponding to the annotation text by processing the second feature sequence by using the speech recognition model. The second feature sequence is constructed based on the speech sample, and is independent of the context information. The apparatus 400 further includes an adjusting module 440, configured to determine a training loss based on at least the difference between the first output probability and the second output probability, to adjust a parameter of the speech recognition model.

In some embodiments, the apparatus 400 further includes a construction module, and the construction module is further configured to: provide the annotation text to a text generation model to generate description text about the annotation text; and construct the context information corresponding to the speech sample based on the description text.

In some embodiments, the first determination module 420 is further configured to: the speech recognition model includes a language model, and the first output probability or the second output probability indicates a probability of a target token, determined by the language model, corresponding to the annotation text.

In some embodiments, the adjusting module 440 is further configured to: determining the training loss based on at least the difference between the first output probability and the second output probability includes: constructing the training loss based on the difference between the first output probability and the second output probability, the training loss including: a first portion corresponding to the first output probability, a second portion corresponding to the second output probability, and a third portion corresponding to the difference.

In some embodiments, the adjusting module 440 is further configured to: the difference includes a JS divergence determined based on the first output probability and the second output probability; or a KL divergence determined based on the first output probability and the second output probability.

In some embodiments, the obtaining module 410 is further configured to: the context information indicates at least one of: text content generated based on historical speech content associated with the speech sample; scenario information for describing a dialogue scenario associated with the speech sample; and object information for describing at least one object associated with the speech sample.

In some embodiments, the first determination module 420 is further configured to: the speech recognition model includes an encoding unit, a conversion unit and a language model, and the method further includes: obtaining target speech content to be processed and target context information associated with the target speech content; generating, using the encoding unit and the conversion unit, a speech feature sequence corresponding to the target speech content; constructing an input feature sequence based on the speech feature sequence, a context feature sequence, and a guidance feature sequence, the context feature sequence corresponding to the target context information, and the guidance feature sequence corresponding to a predetermined guidance item; and processing the input feature sequence using the language model to generate a speech recognition result for the target speech content.

FIG. 5 illustrates a block diagram of an electronic device 500 in which one or more embodiments in the present disclosure may be implemented. It should be understood that the electronic device 500 illustrated in FIG. 5 is merely illustrative and should not constitute any limitation on the functionality and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor capable of performing various processes according to a program stored in the memory 520. In a multiprocessor system, a plurality of processing units executes computer-executable instructions in parallel to improve the parallel processing capabilities of electronic device 500.

The electronic device 500 typically includes a variety of computer storage media. Such media may be any available media that are accessible to the electronic device 500, including, but not limited to, volatile and non-volatile media, removable and non-removable media. The memory 520 may be a volatile memory (e.g., a register, cache, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, magnetic disk, or any other medium that can be used to store information and/or data and that can be accessed within the electronic device 500.

The electronic device 500 may further include an additional removable/non-removable, volatile/non-volatile storage medium. Although not shown in FIG. 5, a disk drive for reading from or writing to a removable, non-volatile magnetic disk (e.g., a “floppy disk”) or an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to execute various methods or actions of the various embodiments in the present disclosure.

The communication unit 540 is configured to communicate with other electronic devices through a communication medium. Additionally, the functionality of components of the electronic device 500 may be implemented by a single computing cluster or multiple computing machines capable of communicating through a communication connection. Thus, the electronic device 500 may operate in a networked environment using a logical connection with one or more other servers, network personal computers (PCs), or another network node.

The input device 550 may be one or more input devices such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed. The external device, such as a storage device, a display device, etc., communicates with one or more devices that enable users to interact with the electronic device 500, or communicates with any device (e.g., a network card, a modem, etc.) that enables the electronic device 500 to communicate with one or more other electronic devices. Such communication may be performed via an input/output (I/O) interface (not shown).

According to example implementations in the present disclosure, a computer-readable storage medium having computer-executable instructions stored thereon is provided. The computer-executable instructions are executed by a processor to implement the method described above. According to example implementations in the present disclosure, a computer program product is further provided. The computer program product is tangibly stored on a non-transitory computer-readable medium and includes computer-executable instructions. The computer-executable instructions are executed by a processor to implement the method described above.

Various aspects in the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processing unit of a general-purpose computer, special computer, or other programmable data processing apparatus to produce a machine that generates an apparatus to implement the functions/acts specified in one or more blocks in the flowchart and/or the block diagram when these instructions are executed through the processing units of the computer or other programmable data processing devices. These computer-readable program instructions may also be stored in a computer-readable storage medium. These instructions cause the computer, programmable data processing apparatus, and/or other devices to work in a specific way. Therefore, the computer-readable medium storing instructions includes an article of manufacture including instructions to implement aspects of the functions/acts specified in one or more blocks in the flowchart and/or block diagram(s).

The computer-readable program instructions may be loaded onto a computer, a programmable data processing apparatus, or a further device, such that a series of operational steps can be performed on the computer, programmable data processing apparatus, or the further device to produce a computer-implemented process. As such, the instructions executed on the computer, programmable data processing apparatus, or the further device implement the functions/acts specified in the one or more blocks in the flowchart and/or block diagram(s).

The flowchart and block diagrams in the drawings show the possible architecture, functions and operations of the system, the method, and the computer program product implemented according to various implementations in the present disclosure. In this regard, each block in the flowchart or block diagram may represent a part of a module, a program segment or instructions, which contains one or more executable instructions for implementing the specified logic function(s). In some alternative implementations, the functions marked in the blocks may also occur in a different order from those marked in the drawings. For example, two consecutive blocks may be executed in parallel, and sometimes can also be executed in a reverse order, depending on the function involved. It should also be noted that each block in the block diagram and/or the flowchart, and combinations of blocks in the block diagram and/or the flowchart, may be implemented by a dedicated hardware-based system that performs the specified functions or acts, or by a combination of a dedicated hardware and computer instructions.

Various implementations in the present disclosure have been described above. The above description is illustrative, not exhaustive, and the present application is not limited to the disclosed implementations. Without departing from the scope and spirit of the described implementations, many modifications and changes are obvious to those skilled in the art. The terminology used herein has been chosen to best explain the principles of the respective implementations, the practical applications or improvements to the technology in the marketplace, or to enable those skilled in the art to understand the implementations disclosed herein.

What is claimed is:

1. A method of context-based speech processing, comprising:
obtaining training data, the training data comprising a speech sample, context information associated with the speech sample, and annotation text corresponding to the speech sample;
determining a first output probability corresponding to the annotation text by processing a first feature sequence using a speech recognition model, wherein the first feature sequence is constructed based on the speech sample and the context information;
determining a second output probability corresponding to the annotation text by processing a second feature sequence using the speech recognition model, wherein the second feature sequence is constructed based on the speech sample and is independent of the context information; and
determining a training loss based on at least a difference between the first output probability and the second output probability to adjust a parameter of the speech recognition model.

2. The method of claim 1, further comprising:
providing the annotation text to a text generation model to generate description text about the annotation text; and
constructing the context information corresponding to the speech sample based on the description text.

3. The method of claim 1, wherein the speech recognition model comprises a language model, and the first output probability or the second output probability indicates a probability of a target token, determined by the language model, corresponding to the annotation text.

4. The method of claim 1, wherein determining the training loss based on at least the difference between the first output probability and the second output probability comprises:
constructing the training loss based on the difference between the first output probability and the second output probability, the training loss comprising: a first portion corresponding to the first output probability, a second portion corresponding to the second output probability, and a third portion corresponding to the difference.

5. The method of claim 1, wherein the difference comprises:
a Jensen-Shannon (JS) divergence determined based on the first output probability and the second output probability; or
a Kullback-Leibler (KL) divergence determined based on the first output probability and the second output probability.

6. The method of claim 1, wherein the context information indicates at least one of:
text content generated based on historical speech content associated with the speech sample;
scenario information for describing a dialogue scenario associated with the speech sample; or
object information for describing at least one object associated with the speech sample.

7. The method of claim 1, wherein the speech recognition model comprises an encoding unit, a conversion unit and a language model, and the method further comprises:
obtaining target speech content to be processed and target context information associated with the target speech content;
generating, using the encoding unit and the conversion unit, a speech feature sequence corresponding to the target speech content;
constructing an input feature sequence based on the speech feature sequence, a context feature sequence, and a guidance feature sequence, the context feature sequence corresponding to the target context information, and the guidance feature sequence corresponding to a predetermined guidance item; and
processing the input feature sequence using the language model to generate a speech recognition result for the target speech content.

8. An electronic device, comprising:
at least one processor; and
at least one memory, coupled to the at least one processor and storing instructions for execution by the at least one processor, the instructions, when executed by the at least one processor, causing the electronic device to perform operations comprising:
obtaining training data, the training data comprising a speech sample, context information associated with the speech sample, and annotation text corresponding to the speech sample;
determining a first output probability corresponding to the annotation text by processing a first feature sequence using a speech recognition model, wherein the first feature sequence is constructed based on the speech sample and the context information;
determining a second output probability corresponding to the annotation text by processing a second feature sequence using the speech recognition model, wherein the second feature sequence is constructed based on the speech sample and is independent of the context information; and
determining a training loss based on at least a difference between the first output probability and the second output probability to adjust a parameter of the speech recognition model.

9. The electronic device of claim 8, wherein the operations further comprise:
providing the annotation text to a text generation model to generate description text about the annotation text; and
constructing the context information corresponding to the speech sample based on the description text.

10. The electronic device according to claim 8, wherein the speech recognition model comprises a language model, and the first output probability or the second output probability indicates a probability of a target token, determined by the language model, corresponding to the annotation text.

11. The electronic device of claim 8, wherein determining the training loss based on at least the difference between the first output probability and the second output probability comprises:
constructing the training loss based on the difference between the first output probability and the second output probability, the training loss comprising: a first portion corresponding to the first output probability, a second portion corresponding to the second output probability, and a third portion corresponding to the difference.

12. The electronic device of claim 8, wherein the difference comprises:
a Jensen-Shannon (JS) divergence determined based on the first output probability and the second output probability; or
a Kullback-Leibler (KL) divergence determined based on the first output probability and the second output probability.

13. The electronic device of claim 8, wherein the context information indicates at least one of:
text content generated based on historical speech content associated with the speech sample;
scenario information for describing a dialogue scenario associated with the speech sample; or
object information for describing at least one object associated with the speech sample.

14. The electronic device according to claim 8, wherein the speech recognition model comprises an encoding unit, a conversion unit and a language model, and the operations further comprise:
obtaining target speech content to be processed and target context information associated with the target speech content;
generating, using the encoding unit and the conversion unit, a speech feature sequence corresponding to the target speech content;
constructing an input feature sequence based on the speech feature sequence, a context feature sequence, and a guidance feature sequence, the context feature sequence corresponding to the target context information, and the guidance feature sequence corresponding to a predetermined guidance item; and
processing the input feature sequence using the language model to generate a speech recognition result for the target speech content.

15. A non-transitory computer-readable storage medium having a computer program stored thereon, the computer program executable by at least one processor to implement operations comprising:
obtaining training data, the training data comprising a speech sample, context information associated with the speech sample, and annotation text corresponding to the speech sample;
determining a first output probability corresponding to the annotation text by processing a first feature sequence using a speech recognition model, wherein the first feature sequence is constructed based on the speech sample and the context information;
determining a second output probability corresponding to the annotation text by processing a second feature sequence using the speech recognition model, wherein the second feature sequence is constructed based on the speech sample and is independent of the context information; and
determining a training loss based on at least a difference between the first output probability and the second output probability to adjust a parameter of the speech recognition model.

16. The non-transitory computer-readable storage medium of claim 15, wherein the operations further comprise:
providing the annotation text to a text generation model to generate description text about the annotation text; and
constructing the context information corresponding to the speech sample based on the description text.

17. The non-transitory computer-readable storage medium according to claim 15, wherein the speech recognition model comprises a language model, and the first output probability or the second output probability indicates a probability of a target token, determined by the language model, corresponding to the annotation text.

18. The non-transitory computer-readable storage medium of claim 15, wherein determining the training loss based on at least the difference between the first output probability and the second output probability comprises:
constructing the training loss based on the difference between the first output probability and the second output probability, the training loss comprising: a first portion corresponding to the first output probability, a second portion corresponding to the second output probability, and a third portion corresponding to the difference.

19. The non-transitory computer-readable storage medium of claim 15, wherein the difference comprises:
a Jensen-Shannon (JS) divergence determined based on the first output probability and the second output probability; or
a Kullback-Leibler (KL) divergence determined based on the first output probability and the second output probability.

20. The non-transitory computer-readable storage medium of claim 15, wherein the context information indicates at least one of:
text content generated based on historical speech content associated with the speech sample;
scenario information for describing a dialogue scenario associated with the speech sample; or
object information for describing at least one object associated with the speech sample.
